(19) United States
(12) Patent Application Publication
(10) Pub. No.: US 2025/0219076 A1
(43) Pub. Date: Jul. 3, 2025

(54) POSITIVE ELECTRODE FOR SECONDARY BATTERY, AND SECONDARY BATTERY

(71) Applicant: MURATA MANUFACTURING CO., LTD., Kyoto (JP)

(72) Inventors: Takumi HIASA, Kyoto (JP); Yoshiaki SUZUKI, Kyoto (JP)

(21) Appl. No.: 19/084,377

(22) Filed: Mar. 19, 2025

Related U.S. Application Data
(63) Continuation of application No. PCT/JP2023/032773, filed on Sep. 8, 2023.

(30) Foreign Application Priority Data
Dec. 14, 2022 (JP) 2022-199729

(51) Int. Cl. H01M 4/58; H01M 4/02; H01M 10/052

(52) U.S. Cl. CPC H01M 4/5815; H01M 10/052; H01M 2004/021; H01M 2004/028

(57) ABSTRACT

A secondary battery includes a positive electrode, a negative electrode, and an electrolytic solution. The positive electrode includes a positive electrode current collector, and a positive electrode active material layer supported by the positive electrode current collector. The positive electrode active material layer includes multiple holding particles each including anatase-type titanium oxide, and multiple positive electrode active material particles each including a sulfur-containing material. The holding particles form a porous structure by being directly joined to each other. The porous structure is directly coupled to the positive electrode current collector. The positive electrode active material particles are each held by any one of the holding particles. The holding particles have an average particle size of 100 nm or less.

### CROSS REFERENCE TO RELATED APPLICATIONS

The present application is a continuation of PCT patent application no. PCT/JP2023/032773, Sep. 8, 2023, which claims priority to Japanese patent application no. 2022-199729, Dec. 14, 2022, the entire contents of which are incorporated herein by reference.

### BACKGROUND

The present technology relates to a positive electrode for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode (a positive electrode for a secondary battery), a negative electrode, and an electrolytic solution. A configuration of the secondary battery has been considered in various ways.

Specifically, used as the positive electrode are a porous body including titanium-nitride nanoparticles, a porous nonwoven web, electrically conductive titanium-oxide nanoparticles, or a sulfur composite (a porous body) including oxygen-reduced titanium oxide (TiO₂₋ₓ).

### SUMMARY

The present technology relates to a positive electrode for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic.

It is desirable to provide a positive electrode for a secondary battery, and a secondary battery that each have a superior battery characteristic.

A positive electrode for a secondary battery according to an embodiment of the present technology includes a positive electrode current collector and a positive electrode active material layer. The positive electrode active material layer is supported by the positive electrode current collector. The positive electrode active material layer includes multiple holding particles each including anatase-type titanium oxide, and multiple positive electrode active material particles each including a sulfur-containing material. The holding particles form a porous structure by being directly joined to each other. The porous structure is directly coupled to the positive electrode current collector. The positive electrode active material particles are each held by any one of the holding particles. The holding particles have an average particle size of 100 nm or less.

A secondary battery according to an embodiment of the present technology includes a positive electrode, a negative electrode, and an electrolytic solution. The positive electrode has a configuration similar to the above-described configuration of the positive electrode for the secondary battery according to an embodiment of the present technology.

Here, the “average particle size of the holding particles” is calculated based on an observation result, e.g., an electron micrograph, obtained by observing a section of the positive electrode active material layer with use of an electron microscope. A definition of the “average particle size”, i.e., a procedure for calculating the average particle size based on the electron micrograph, will be described in detail later.

According to the positive electrode for the secondary battery, or the secondary battery of an embodiment of the present technology, the positive electrode for the secondary battery includes the positive electrode current collector and the positive electrode active material layer. The positive electrode active material layer includes the holding particles and the positive electrode active material particles. The holding particles each include the anatase-type titanium oxide. The positive electrode active material particles each include the sulfur-containing material. The holding particles form the porous structure by being directly joined to each other. The porous structure is directly coupled to the positive electrode current collector. The positive electrode active material particles are each held by any one of the holding particles. The holding particles have the average particle size of 100 nm or less. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a sectional diagram illustrating a configuration of a positive electrode for a secondary battery according to an embodiment of the present technology.

FIG. 2 is a sectional diagram illustrating, in an enlarged manner, a configuration of a portion of the positive electrode for the secondary battery illustrated in FIG. 1.

FIG. 3 is a schematic diagram illustrating an electron micrograph of a section of the positive electrode for the secondary battery illustrated in FIG. 1.

FIG. 4 is a perspective diagram illustrating a configuration of a secondary battery according to an embodiment of the present technology.

FIG. 5 is a sectional diagram illustrating a configuration of a battery device illustrated in FIG. 4.

FIG. 6 is a sectional diagram illustrating a configuration of a test secondary battery.

### DETAILED DESCRIPTION

The present technology is described below in further detail including with reference to the drawings.

A description is given first of a positive electrode for a secondary battery according to an embodiment of the present technology. The positive electrode for the secondary battery is hereinafter simply referred to as the “positive electrode”.

The positive electrode to be described here is to be used in a secondary battery, which is an electrochemical device. However, the positive electrode may be used in electrochemical devices other than the secondary battery. Specific examples of the other electrochemical devices include a primary battery and a capacitor.

The positive electrode operates by using an electrochemical reaction of a sulfur-containing material in the electrochemical device. In a secondary battery including the positive electrode, the sulfur-containing material is electrochemically oxidized upon discharging, and is electrochemically reduced upon charging. Details of the sulfur-containing material will be described later.

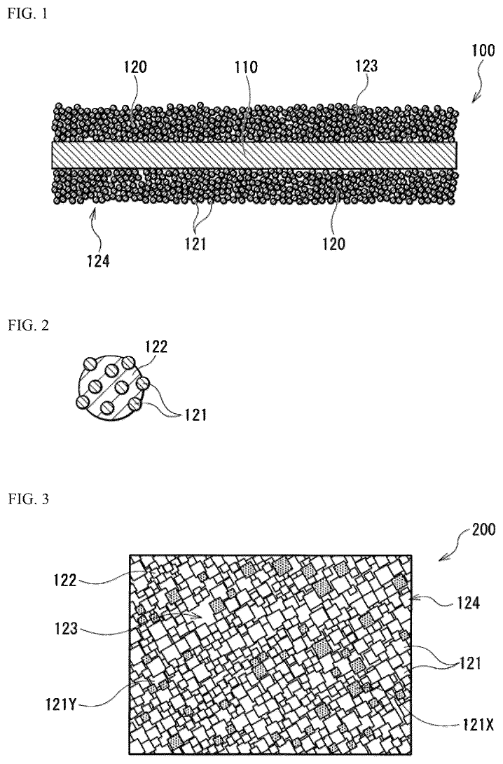

FIG. 1 illustrates a sectional configuration of a positive electrode 100 as an example of the positive electrode. FIG. 2 illustrates, in an enlarged manner, a sectional configuration of a portion of the positive electrode 100 illustrated in FIG. 1. FIG. 3 schematically illustrates an electron micrograph 200 of a section of the positive electrode 100 illustrated in FIG. 1.

The positive electrode 100 includes, as illustrated in FIG. 1, a positive electrode current collector 110 and a positive electrode active material layer 120.

As illustrated in FIG. 1, the positive electrode current collector 110 is an electrically conductive support that supports the positive electrode active material layer 120, and has two opposed surfaces, i.e., an upper surface and a lower surface, on each of which the positive electrode active material layer 120 is to be provided.

The positive electrode current collector 110 includes any one or more of electrically conductive materials including, without limitation, a metal material. Specific examples of the electrically conductive material include titanium, aluminum, a titanium alloy, and an aluminum alloy.

The positive electrode active material layer 120 is a place or a layer in which the sulfur-containing material electrochemically reacts. The positive electrode active material layer 120 is supported by the positive electrode current collector 110, as illustrated in FIG. 1. The positive electrode active material layer 120 includes a positive electrode active material including the sulfur-containing material, and a holding body that holds the positive electrode active material. Note that the positive electrode active material layer 120 may further include any one or more of other materials including, without limitation, a positive electrode binder and a positive electrode conductor.

Here, the positive electrode active material layer 120 is provided on each of the two opposed surfaces, i.e., the upper and lower surfaces, of the positive electrode current collector 110. However, the positive electrode active material layer 120 may be provided only on one of the two opposed surfaces, i.e., only on the upper surface or the lower surface, of the positive electrode current collector 110.

In particular, the positive electrode active material layer 120 includes two kinds of multiple particles, as illustrated in FIGS. 1 and 2. The particles of the first kind are multiple holding particles 121 that form the above-described holding body, which serves as a porous structure 124 to be described later. The particles of the second kind are multiple positive electrode active material particles 122 that are each the positive electrode active material having a particle shape.

The holding particles 121 each include anatase-type titanium oxide (TiO₂). That is, the titanium oxide included in the holding particles 121 has an anatase-type crystal structure. The holding particles 121 described above are each not a secondary particle, which is an aggregate of primary particles, but are each the primary particle itself.

For example, the anatase-type titanium oxide includes any one or more of compounds represented by Formula (1).

TiO_{w} (1)

where w satisfies 1.85≤w≤2.15.

Note that the anatase-type titanium oxide may include any one or more of dopants. The one or more dopants are each an element with which the anatase-type titanium oxide is to be doped. The one or more dopants are not particularly limited in kind as long as the one or more dopants are each an element that allows the anatase-type titanium oxide to be doped therewith. The kind of each of the one or more dopants may be appropriately selected for the purpose of improving an electrically conductive property of the porous structure 124 that is the holding body and for the purpose of accelerating formation of the porous structure 124. Specific examples of the one or more dopants include Nb, Ta, Fe, Zr, La, As, P, and B. Note that in terms of costs, the anatase-type titanium oxide including no dopant is preferable to the anatase-type titanium oxide including the one or more dopants.

One reason why the holding particles 121 include the anatase-type titanium oxide is that this facilitates stable proceeding of an electrochemical reaction of the positive electrode active material particles 122 (the sulfur-containing material) in the positive electrode active material layer 120, as compared with when the holding particles 121 include rutile-type or brookite-type titanium oxide.

In more detail, the anatase-type titanium oxide has a property that easily accelerates the electrochemical reaction of the sulfur-containing material, as compared with the rutile-type or brookite-type titanium oxide. Accordingly, the holding particles 121 including the anatase-type titanium oxide facilitate stable proceeding of the electrochemical reaction of the sulfur-containing material, as compared with the holding particles 121 including the rutile-type or brookite-type titanium oxide.

The holding particles 121 form the porous structure 124 by being directly joined to each other. Thus, the positive electrode active material layer 120 includes the porous structure 124 in which the holding particles 121, which are the primary particles, are directly joined to each other, and the porous structure 124 has multiple voids, i.e., fine pores 123.

In more detail, the positive electrode active material layer 120 includes a sintered body of the holding particles 121 formed by a firing method. The sintered body serves as the above-described holding body, i.e., the porous structure 124. The holding particles 121 are thus directly joined to each other inside the positive electrode active material layer 120, as described above. A method of forming the positive electrode active material layer 120 by the firing method will be described in detail later.

The wording “directly joined to each other” refers to that the porous structure 124 is the sintered body of the holding particles 121, as described above. In other words, the holding particles 121 are not indirectly joined to each other via a binder, but are directly joined to each other without the binder therebetween to form the porous structure 124. Further, the holding particles 121 are not indirectly joined to each other via a conductor to form the porous structure 124, thus not being electrically coupled to each other via the conductor. Instead, the holding particles 121 are directly joined to each other without the conductor therebetween to form the porous structure 124, thus being electrically coupled to each other without the conductor therebetween.

One reason why the positive electrode active material layer 120 includes the porous structure 124, which is the sintered body of the holding particles 121, is that this allows the holding particles 121 to be physically and electrically coupled to each other. This increases an energy density per volume of the positive electrode active material layer 120, and improves electron conductivity between the holding particles 121. Thus, electric resistance decreases while the energy density is secured in the positive electrode 100, which allows the secondary battery including the positive electrode 100 to obtain a high discharge capacity.

The porous structure 124 is directly coupled to the positive electrode current collector 110. Accordingly, a part of the holding particles 121 forming the porous structure 124 is directly coupled to the positive electrode current collector 110, in addition to that the holding particles 121 are directly joined to each other to form the porous structure 124.

The wording “directly coupled to each other” refers to that a part of the holding particles 121 is not indirectly coupled to the positive electrode current collector 110 via the binder or the conductor, but is directly coupled to the positive electrode current collector 110 without the binder or the conductor therebetween.

The holding particles 121 thus form the porous structure 124, which is to be a skeleton of the positive electrode active material layer 120, by being directly joined to each other as illustrated in FIG. 1. In this case, as illustrated in FIG. 2, the holding particle 121 holds multiple positive electrode active material particles 122. That is, the holding particles 121 each hold multiple positive electrode active material particles 122. Note that FIG. 2 illustrates only one holding particle 121 to simplify the illustration.

Here, the holding particles 121 forming the porous structure 124 have an average particle size AS that is sufficiently small. Specifically, the average particle size AZ of the holding particles 121 is 100 nm or less. That is, the average particle size AS has what is called a value in order of nanometers, and the holding particles 121 are thus what is called nanoparticles. One reason for this is that this increases an energy density per weight of the positive electrode active material layer 120, and facilitates formation of a movement path (the fine pores 123) for the sulfur-containing material inside the positive electrode active material layer 120. This accelerates the electrochemical reaction of the positive electrode active material particles 122 (the sulfur-containing material) at surfaces of the holding particles 121, and thus facilitates stable proceeding of the electrochemical reaction. Accordingly, a battery capacity of the secondary battery including the positive electrode 100 increases.

In particular, the average particle size AS is preferably 30 nm or less. One reason for this is that this further accelerates the electrochemical reaction of the positive electrode active material particles 122 (the sulfur-containing material) at the surfaces of the holding particles 121. Another reason is that this further increases the energy density per weight of the positive electrode active material layer 120, and further facilitates the formation of the fine pores 123 inside the positive electrode active material layer 120.

Note that the average particle size AS is not particularly limited in lower-limit value. Specifically, the average particle size AS is preferably 7 nm or greater. One reason for this is that this facilitates stable formation of the holding particles 121.

A procedure for calculating the average particle size AS is as described below. The electron micrograph 200 is used to calculate the average particle size AS.

Specifically, first, the positive electrode 100 is cut in a thickness direction, i.e., an up-down direction in FIG. 1, to expose the section of the positive electrode 100. In this case, the positive electrode 100 is cut by a cutting apparatus such as an ion milling apparatus to thereby expose the section of the positive electrode active material layer 120. Note that, for example, an ion milling apparatus ArBlade (registered trademark) 5000 available from Hitachi High-Tech Corporation may be used as the ion milling apparatus.

Thereafter, the electron micrograph 200 is obtained by observing the section of the positive electrode active material layer 120 with use of an electron microscope. The electron microscope is not particularly limited in kind. Specifically, any one or more of electron microscopes including, without limitation, a scanning electron microscope (SEM) and a transmission electron microscope (TEM) are used. Observation conditions are not particularly limited; however, specific observation conditions include an acceleration voltage of 5.0 kV and a magnification of 150 thousand times.

In the electron micrograph 200, as illustrated in FIG. 3, the porous structure 124 having the fine pores 123 is observed because the holding particles 121 are directly joined to each other. To simplify the illustration, FIG. 3 illustrates each of the holding particles 121 with a rectangular plan shape, and omits illustration of the positive electrode active material particles 122.

Thereafter, any 50 holding particles 121 are selected from the holding particles 121 visually recognized in the electron micrograph 200, following which a particle size S (a maximum outer size) of each of the 50 holding particles 121 is measured. As a result, 50 particle sizes S are obtained.

When the 50 holding particles 121 are to be selected, the holding particles 121 present in the very front are selected among the holding particles 121 overlapping each other. In other words, the holding particle 121 (121Y) is not selected whose outer edge is not entirely visible because the holding particle 121 and other one or more holding particles 121 overlap each other. In contrast, the holding particle 121 (121X) is selected whose outer edge is entirely visible because the holding particle 121 and other one or more holding particles 121 do not overlap each other. In FIG. 3, some holding particles 121X to be selected are shaded.

Lastly, an average value of the 50 particle sizes S is calculated to thereby obtain the average value as the average particle size AS.

Note that a series of configuration conditions regarding the positive electrode active material layer 120 may be set as desired. The series of configuration conditions includes, for example, a volume density (g/cm³), a specific surface area (m²/g), and a void rate (%).

The positive electrode active material particles 122 are each held by any one of the holding particles 121, as illustrated in FIGS. 1 and 2. Here, the positive electrode active material particles 122 are each absorbed on the surface of the corresponding one of the holding particles 121. Note that FIG. 1 omits illustration of the positive electrode active material particles 122.

One reason why the positive electrode active material particles 122 are each held by any one of the holding particles 121 is that this facilitates sufficient and stable proceeding of the electrochemical reaction of the positive electrode active material particles 122 at the surfaces of the holding particles 121. This allows the secondary battery including the positive electrode 100 to stably obtain a sufficient battery capacity.

The positive electrode active material particles 122 each include any one or more of the sulfur-containing materials, as described above. The term “sulfur-containing material” is a generic term for a material including sulfur as a constituent element. That is, the sulfur-containing material may be a simple substance of sulfur, a sulfur alloy, a sulfur compound, a mixture of two or more thereof, or a material including one or more phases thereof. The simple substance of sulfur is hereinafter referred to as “simple-substance sulfur”.

Note that the “simple substance” described here merely refers to a simple substance in a general sense. The simple substance may therefore include a small amount of impurity. That is, purity of the simple substance does not necessarily have to be 100%.

Note that the sulfur compound may include a salt. The salt includes an anion including sulfur as a constituent element, and any cation. The anion including sulfur is hereinafter referred to as a “sulfur-containing anion”. The cation is not particularly limited in kind. In particular, however, a cation is preferable that allows the electrochemical reaction to proceed in the secondary battery including the positive electrode 100. One reason for this is that this increases the energy density.

Specifically, the cation is an ion of a light metal such as an alkali metal or an alkaline earth metal. Specific examples of the alkali metal include lithium, sodium, and potassium. Specific examples of the alkaline earth metal include beryllium, magnesium, and calcium.

Specific examples of the sulfur-containing material include simple-substance sulfur, an alkali metal sulfide, an alkaline earth metal sulfide, an alkali metal polysulfide, and an alkaline earth metal polysulfide. In particular, the sulfur-containing material preferably includes the alkali metal polysulfide, and more preferably includes a lithium polysulfide. One reason for this is that this facilitates sufficient proceeding of the electrochemical reaction of the positive electrode active material particles 122. Specific examples of the lithium polysulfide include lithium sulfide (Li₂S₈).

When the sulfur-containing anion includes a polysulfide ion (Sₙ^{x-}), a range of each of n and x is not particularly limited. Specifically, n preferably satisfies 2≤n≤20, and more preferably satisfies 2<n≤12. x preferably satisfies 0<x≤2, and is more preferably 2.

The positive electrode binder includes any one or more of materials including, without limitation, a synthetic rubber and a polymer compound. Specific examples of the synthetic rubber include a styrene-butadiene-based rubber. Specific examples of the polymer compound include polyethylene glycol, polyvinylidene difluoride, and polyimide.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The positive electrode 100 operates as below.

In an electrode reaction (upon discharging of the secondary battery including the positive electrode 100 and an electrolytic solution to be described later), the positive electrode active material particles 122 (the sulfur-containing material) are electrochemically reduced at the surfaces of the holding particles 121 in the positive electrode active material layer 120. In this case, when the sulfur-containing material includes a sulfur-containing anion having high solubility, the salt including the sulfur-containing anion is sometimes eluted from the holding particles 121 into the electrolytic solution.

In the electrode reaction (upon charging of the secondary battery including the positive electrode 100 and the electrolytic solution to be described later), the positive electrode active material particles 122 (the sulfur-containing material) are electrochemically oxidized at the surfaces of the holding particles 121 in the positive electrode active material layer 120. In this case, when the sulfur-containing material includes the sulfur-containing anion having the high solubility, the salt, which is included in the electrolytic solution, that includes the sulfur-containing anion is electrochemically oxidized, and thus precipitates on the surfaces of the holding particles 121. Such precipitation of the salt sometimes results in formation of a part or all of the positive electrode active material particles 122.

For example, when the sulfur-containing material is simple-substance sulfur (S₈), an electrochemical reaction represented by Equation (2) proceeds.

$$n / 8 {S}_{8} + {x}^{e -} = {S}_{n}^{x -} \qquad ( 2 )$$

where:
n satisfies 2≤n≤20, and
x satisfies 0<x≤2.

As is apparent from Equation (2), upon discharging, simple-substance sulfur is reduced and turns into a polysulfide ion. Upon charging, the polysulfide ion is oxidized and turns into simple-substance sulfur. Note that upon discharging, the positive electrode active material particles 122 are reduced, which causes simple-substance sulfur to be a salt including the polysulfide ion. However, a part or all of the salt may be dissolved by the electrolytic solution. Upon charging, the salt including the polysulfide ion, which serves as the positive electrode active material particles 122, may be oxidized. Alternatively, the salt including the polysulfide ion, which is dissolved in the electrolytic solution, may be oxidized, and a part or all of the positive electrode active material particles 122 may thereby be formed.

The positive electrode 100 is manufactured by the following example procedure.

First, the holding particles 121 (the anatase-type titanium oxide), the positive electrode binder, and a solvent are mixed with each other to thereby obtain a paste. In this case, used are the holding particles 121 having the average particle size AS of 100 nm or less. The solvent is not particularly limited in kind, and is specifically an aqueous solvent such as water. A paste including the aqueous solvent as the solvent is what is called an aqueous paste. Note that a composition, i.e., a mixture ratio, of the paste may be set as desired.

Thereafter, the paste is applied on the two opposed surfaces of the positive electrode current collector 110 to thereby form coating films, following which the positive electrode current collector 110 with the coating films formed thereon is pressed. Pressing conditions may be set as desired. This allows the coating films to be compression-bonded to the two respective opposed surfaces of the positive electrode current collector 110.

Thereafter, the positive electrode current collector 110 with the coating films formed thereon is fired in the atmosphere. Firing conditions including, without limitation, a firing temperature and a firing time may be set as desired. In this case, the firing conditions are adjusted to allow the holding particles 121, which include the anatase-type titanium oxide, to be directly joined to each other while being maintained in the primary particle state. For example, a highest temperature during firing is within a range from 500° C. to 1200° C. both inclusive. Note that an environment condition for the firing is not particularly limited, and the firing process may be performed in an oxygen atmosphere.

In the firing process, the positive electrode binder is degreased in accordance with the firing. Thus, the holding particles 121 are directly joined to each other, and the porous structure 124 having the fine pores 123 is thereby formed. In this case, a portion of the porous structure 124, i.e., a part of the holding particles 121, is directly coupled to the positive electrode current collector 110.

Thereafter, the sulfur-containing material is added to a solvent, following which the solvent is stirred to thereby prepare a sulfur-containing solution. The solvent is not particularly limited in kind, and is specifically an organic solvent, for example.

Lastly, the positive electrode current collector 110 with the porous structure 124 formed thereon is immersed in the sulfur-containing solution, following which the positive electrode current collector 110 with the porous structure 124 formed thereon is taken out of the sulfur-containing solution and is dried. Immersion conditions including, without limitation, an immersion time may be set as desired. This allows the positive electrode active material particles 122 (the sulfur-containing material) to each be held by any one of the holding particles 121.

Thus, the positive electrode active material layer 120 including the holding particles 121 (the porous structure 124) and the positive electrode active material particles 122 is formed. The positive electrode 100 is thus completed.

Note that when the positive electrode 100 is to be fabricated, any method may be used other than the above-described method of firing the coating films including the positive electrode binder. The procedure for fabricating the positive electrode 100 may be appropriately changed as long as the porous structure 124 is formable by the firing process.

Specifically, the holding particles 121 may be obtained by press-molding without using the positive electrode binder, following which the holding particles 121 may be fired. Alternatively, a dispersion liquid in which the holding particles 121 are dispersed may be applied on the two opposed surfaces of the positive electrode current collector 110, and the applied dispersion liquid may be dried, following which the positive electrode current collector 110 with the dispersion liquid applied thereon may be fired.

According to the positive electrode 100, the positive electrode 100 includes the positive electrode current collector 110 and the positive electrode active material layer 120. The positive electrode active material layer 120 includes the holding particles 121 (the anatase-type titanium oxide) and the positive electrode active material particles 122 (the sulfur-containing material). The positive electrode active material layer 120 includes the porous structure 124. The porous structure 124 is formed by the holding particles 121 being directly joined to each other, and is directly coupled to the positive electrode current collector 110. The positive electrode active material particles 122 are each held by any one of the holding particles 121. The average particle size AS of the holding particles 121 is 100 nm or less.

In this case, the following series of kinds of action is achieved, as described above.

Firstly, because the positive electrode active material layer 120 includes the porous structure 124 that is the sintered body of the holding particles 121, the holding particles 121 are physically and electrically coupled to each other. This increases an energy density of the positive electrode active material layer 120, and improves the electron conductivity between the holding particles 121. Thus, the electric resistance decreases while the energy density is secured.

Secondly, because the holding particles 121 each include the anatase-type titanium oxide, stable proceeding of the electrochemical reaction of the positive electrode active material particles 122 (the sulfur-containing material) is facilitated in the positive electrode active material layer 120.

Thirdly, because the average particle size AS of the holding particles 121 is 100 nm or less, the energy density per weight of the positive electrode active material layer 120 increases, and formation of the movement path (the fine pores 123) for the sulfur-containing material is facilitated inside the positive electrode active material layer 120.

The above-described series of kinds of action facilitates proceeding of the electrochemical reaction of the sulfur-containing material in the positive electrode 100. In addition, the positive electrode 100 including the porous structure 124 is easily manufactured by the existing firing method. This makes it easy to stably obtain a sufficient discharge capacity upon charging and discharging, and thus makes it possible to achieve a secondary battery having a superior battery capacity by using the positive electrode 100.

In particular, the average particle size AS may be 30 nm or less. This further facilitates movement of the sulfur-containing material inside the positive electrode active material layer 120, further increases the energy density per weight of the positive electrode active material layer 120, and further facilitates the formation of the movement path (the fine pores 123) for the sulfur-containing material inside the positive electrode active material layer 120. Accordingly, it is possible to achieve higher effects.

Further, the sulfur-containing material may include the alkali metal polysulfide. This facilitates sufficient proceeding of the electrochemical reaction of the sulfur-containing material. Accordingly, it is possible to achieve higher effects. In this case, the alkali metal polysulfide may include the lithium polysulfide. This further facilitates the electrochemical reaction of the positive electrode active material particles 122. Accordingly, it is possible to achieve even higher effects.

Next, a description is given of a secondary battery according to an embodiment of the present technology to which the positive electrode 100 is to be applied.

The secondary battery to be described here is a secondary battery in which a battery capacity is obtained through an electrochemical reaction of an electrode reactant, and includes a positive electrode, a negative electrode, and an electrolytic solution.

The negative electrode obtains a capacity by using an electrochemical reaction of a cation included in the electrolytic solution. In this case, preferably used is an electrochemical reaction of a cation that is able to form a salt with the sulfur-containing anion. One reason for this is that this increases an energy density of the secondary battery. A negative electrode active material in this case is a material that allows for an electrochemical reaction with the cation that is able to form a salt with the sulfur-containing anion.

Specifically, the cation is an ion of a light metal such as an alkali metal or an alkaline earth metal. Specific examples of the alkali metal include lithium, sodium, and potassium. Specific examples of the alkaline earth metal include beryllium, magnesium, and calcium.

In this case, the negative electrode active material includes an alkali metal material, an alkaline earth metal material, or both. The alkali metal material is a material that includes an alkali metal element as a constituent element. The alkaline earth metal material is a material that includes an alkaline earth metal element as a constituent element. Note that only one alkali metal element may be included, or two or more alkali metal elements may be included. Only one alkaline earth metal element may be included, or two or more alkaline earth metal elements may be included. In addition, the alkali metal material and the alkaline earth metal material may each be a simple substance, an alloy, a compound, or a material including two or more thereof. Note that the meaning of the “simple substance” is as described above.

The following description deals with an example case where the cation is a lithium ion. A secondary battery in which a capacity is obtained through insertion and extraction of lithium at a negative electrode is what is called a lithium-sulfur secondary battery.

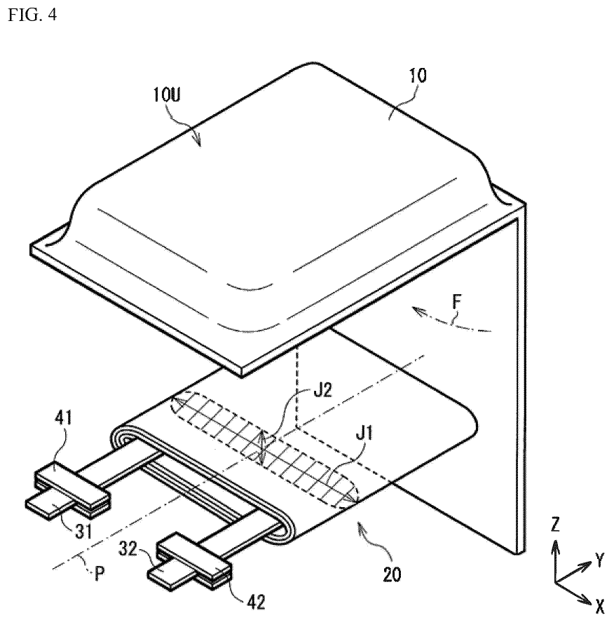

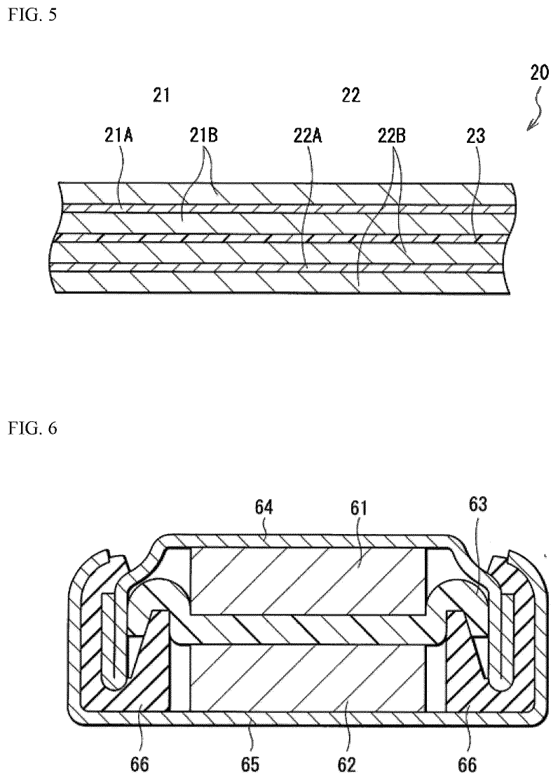

FIG. 4 illustrates a perspective configuration of the secondary battery. FIG. 5 illustrates a sectional configuration of a battery device 20 illustrated in FIG. 4. Note that FIG. 4 illustrates a state where an outer package film 10 and the battery device 20 are separated from each other, and illustrates a section of the battery device 20 along an XZ plane by a dashed line.

As illustrated in FIGS. 4 and 5, the secondary battery includes the outer package film 10, the battery device 20, a positive electrode lead 31, a negative electrode lead 32, and sealing films 41 and 42.

The secondary battery described here includes the outer package film 10 that is flexible or soft as an outer package member that is to contain the battery device 20, as described above, and is thus a secondary battery of what is called a laminated-film type.

As illustrated in FIG. 4, the outer package film 10 has a pouch-shaped structure that is sealed in a state where the battery device 20 is contained in the outer package film 10. The outer package film 10 thus contains a positive electrode 21, a negative electrode 22, a separator 23, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained in the outer package film 10. The battery device 20 is what is called a power generation device, and includes, as illustrated in FIGS. 4 and 5, the positive electrode 21, the negative electrode 22, the separator 23, and the electrolytic solution (not illustrated).

Here, the battery device 20 is what is called a wound electrode body. That is, the positive electrode 21 and the negative electrode 22 are wound about a winding axis P, being opposed to each other with the separator 23 interposed therebetween. As is apparent from FIG. 4, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 has a configuration similar to that of the positive electrode 100. That is, the positive electrode 21 includes, as illustrated in FIG. 5, a positive electrode current collector 21A and a positive electrode active material layer 21B. The positive electrode current collector 21A has a configuration similar to that of the positive electrode current collector 110. The positive electrode active material layer 21B has a configuration similar to that of the positive electrode active material layer 120.

The negative electrode 22 includes, as illustrated in FIG. 5, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials into which lithium is insertable and from which lithium is extractable. Note that the negative electrode active material layer 22B may further include any one or more of other materials including, without limitation, a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material, a metal-based material, and lithium metal, i.e., what is called a simple substance of lithium. One reason for this is that this allows for a high energy density. Note that the meaning of the “simple substance” is as described above.

The carbon material is not particularly limited in kind, and specific examples thereof include non-graphitizable carbon, graphitizable carbon, graphite (natural graphite and artificial graphite), pyrolytic carbons, cokes, glassy carbons, an organic polymer compound fired body, a carbon fiber, and activated carbon. Examples of the cokes include pitch coke, needle coke, and petroleum coke. The organic polymer compound fired body may be a material in which a polymer compound such as a phenol resin or a furan resin is carbonized by being fired at a suitable temperature. Note that some organic polymer compound fired bodies are classified into the non-graphitizable carbon or the graphitizable carbon.

The carbon material is preferable in that the carbon material undergoes a very little change in crystal structure upon charging and discharging, and thus allows for high charge and discharge capacities. The carbon material is also preferable in that the carbon material allows for a favorable cyclability characteristic. Graphite is preferable in particular in that graphite has a large electrochemical equivalent and allows for a high energy density. The non-graphitizable carbon is preferable in that the non-graphitizable carbon allows for a superior cyclability characteristic. A carbon material having low charge and discharge potentials, more specifically, a carbon material having charge and discharge potentials close to those of lithium metal is preferable in that such a carbon material easily allows for an increase in energy density of the secondary battery.

The metal-based material is a material that includes, as one or more constituent elements, any one or more elements among metal elements and metalloid elements that are each able to form an alloy with lithium. Specific examples of the metal elements and the metalloid elements include magnesium, boron, aluminum, titanium, gallium, indium, silicon, germanium, tin, lead, bismuth, cadmium, silver, zinc, hafnium, zirconium, yttrium, palladium, and platinum.

The metal-based material may be crystalline, or may be amorphous. More specifically, the metal-based material may be a simple substance, an alloy, a compound, a mixture of two or more thereof, or a material including two or more phases thereof. Note that the meaning of the “simple substance” is as described above. The alloy includes not only a material including two or more metal elements as constituent elements, but may also include a material including one or more metal elements and one or more metalloid elements as constituent elements. Further, the alloy may include one or more non-metallic elements as one or more constituent elements. The alloy is not particularly limited in state, but may specifically be a solid solution, a eutectic (a eutectic mixture), an intermetallic compound, or in a state including two or more thereof that coexist.

In particular, the metal-based material preferably includes, as a constituent element, a metal element or a metalloid element belonging to group 4B in the short period periodic table. The metal-based material more preferably includes silicon, tin, or both as one or more constituent elements. One reason for this is that a sufficiently high energy density is obtainable.

The silicon alloy includes any one or more of tin, nickel, copper, iron, cobalt, manganese, zinc, indium, silver, titanium, germanium, bismuth, antimony, niobium, molybdenum, aluminum, phosphorous, gallium, or chromium as one or more constituent elements other than silicon. The tin alloy includes any one or more of silicon, nickel, copper, iron, cobalt, manganese, zinc, indium, silver, titanium, germanium, bismuth, antimony, niobium, molybdenum, aluminum, phosphorous, gallium, or chromium as one or more constituent elements other than tin.

The silicon compound and the tin compound each include any one or more of elements including, without limitation, oxygen and carbon as one or more constituent elements. Note that the silicon compound and the tin compound may each include, as one or more constituent elements, any one or more of the series of elements described in relation to the silicon alloy.

In particular, when the metal-based material is a material including tin as a constituent element, the metal-based material is preferably a low-crystalline or amorphous material including cobalt, tin, and carbon as constituent elements. One reason for this is that this allows for a sufficiently high energy density.

Other than the above, the negative electrode active material may be a metal oxide or a polymer compound into which lithium is insertable and from which lithium is extractable. The metal oxide is not particularly limited in kind, and specific examples thereof include a lithium-titanium oxide, an iron oxide, a ruthenium oxide, and a molybdenum oxide. Specific examples of the lithium-titanium oxide include lithium titanate (Li₄Ti₅O₁₂). Specific examples of the polymer compound include polyacetylene, polyaniline, and polypyrrole.

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 5, and allows lithium to pass therethrough in an ionic state while preventing occurrence of a short circuit caused by contact between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

The solvent includes any one or more of non-aqueous solvents (organic solvents). The electrolytic solution including the one or more non-aqueous solvents is what is called a non-aqueous electrolytic solution.

The non-aqueous solvent includes, for example, an ester or an ether, more specifically, any one or more of a carbonic-acid-ester-based compound, a carboxylic-acid-ester-based compound, or a lactone-based compound. One reason for this is that this improves a dissociation property of the electrolyte salt and ion mobility.

The carbonic-acid-ester-based compound is a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, tetrahydrofuran, 1,3-dioxolane, or 1,4-dioxane. Other than the above-described material, the ether may be a compound represented by Formula (3). This compound is a straight-chain ether having an ethylene oxide structure unit as a repeating unit. Specific examples of such a compound include 1,2-dimethoxy ethane, diethylene glycol dimethyl ether, and tetraethylene glycol dimethyl ether.

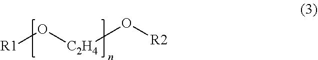

where:
each of R1 and R2 is an alkyl group having carbon number from 1 to 10 both inclusive; and
n is an integer within a range from 1 to 10 both inclusive.

Further, the non-aqueous solvent includes any one or more of solvents including, without limitation, an unsaturated cyclic carbonic acid ester, a fluorinated cyclic carbonic acid ester, a sulfonic acid ester, a phosphoric acid ester, an acid anhydride, a nitrile compound, and an isocyanate compound. One reason for this is that this similarly improves the dissociation property of the electrolyte salt and the ion mobility.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato)borate (LiB(C₂O₄)₂), lithium monofluorophosphate (Li₂PFO₃), lithium difluorophosphate (LiPF₂O₂), and lithium nitrate (LiNO₃). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that this allows for high ion conductivity.

As illustrated in FIGS. 4 and 5, the positive electrode lead 31 is a positive electrode wiring coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 4 and 5, the negative electrode lead 32 is a negative electrode wiring coupled to the negative electrode 22, and is led to the outside of the outer package film 10. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is disposed between the outer package film 10 and the positive electrode lead 31, as illustrated in FIG. 4. The sealing film 42 is disposed between the outer package film 10 and the negative electrode lead 32, as illustrated in FIG. 4. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below upon charging and discharging.

Upon charging, in the battery device 20, lithium is extracted from the positive electrode 21, and the extracted lithium is inserted into the negative electrode 22 via the electrolytic solution. Upon discharging, in the battery device 20, lithium is extracted from the negative electrode 22, and the extracted lithium is inserted into the positive electrode 21 via the electrolytic solution. Upon each of the discharging and the charging, lithium is inserted and extracted in an ionic state.

When the secondary battery is to be manufactured, the positive electrode 21 and the negative electrode 22 are each prepared, and the electrolytic solution is prepared, following which the secondary battery is assembled using the positive electrode 21, the negative electrode 22, and the electrolytic solution, and the assembled secondary battery is subjected to a stabilization process, in accordance with an example procedure described below.

The positive electrode 21 is fabricated in accordance with a procedure similar to the manufacturing procedure of the positive electrode 100. In this case, the positive electrode active material layer 21B is formed on each of two opposed surfaces of the positive electrode current collector 21A.

First, the negative electrode active material, the negative electrode binder, and the negative electrode conductor are mixed with each other to thereby obtain a negative electrode mixture. Thereafter, the negative electrode mixture is put into a solvent to thereby prepare a negative electrode mixture slurry in paste form. The solvent may be an aqueous solvent, or may be an organic solvent. Lastly, the negative electrode mixture slurry is applied on the two opposed surfaces of the negative electrode current collector 22A to thereby form the negative electrode active material layers 22B. Thereafter, the negative electrode active material layers 22B may be compression-molded by, for example, a roll pressing machine. In this case, the negative electrode active material layers 22B may be heated. The negative electrode active material layers 22B may be compression-molded multiple times. The negative electrode active material layers 22B are thus formed on the two respective opposed surfaces of the negative electrode current collector 22A. The negative electrode 22 is thus fabricated.

The electrolyte salt is put into the solvent. The electrolyte salt is thereby dispersed or dissolved in the solvent. The electrolytic solution is thus prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by, for example, a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus formed. Accordingly, the battery device 20 is sealed in the outer package film 10 having the pouch shape. The secondary battery is thus completed.

According to the secondary battery, the positive electrode 21 has the configuration similar to that of the positive electrode 100. It is therefore possible to easily and stably obtain a sufficient discharge capacity upon charging and discharging, and to thus achieve a superior battery characteristic, for the reason described above.

In particular, the secondary battery may include a lithium-sulfur secondary battery. This makes it possible to stably obtain a sufficient battery capacity through insertion and extraction of lithium. Accordingly, it is possible to achieve higher effects.

The configuration of the secondary battery is appropriately modifiable as described below. Note that any two or more of the following series of modification examples may be combined with each other.

Regarding the positive electrode 100 described above, the example case has been described in which the sulfur-containing material includes the alkali metal polysulfide, and the alkali metal polysulfide includes the lithium polysulfide. However, the alkali metal polysulfide may include a sodium polysulfide.

A secondary battery that includes the positive electrode 21 to which the positive electrode 100 is applied, and the negative electrode 22, and in which the battery capacity is obtained through insertion and extraction of sodium is what is called a sodium-sulfur secondary battery.

The sodium-sulfur secondary battery has a configuration that is similar to the above-described configuration of the lithium-sulfur secondary battery except for the following points. The negative electrode active material is not particularly limited in kind, and specific examples thereof include a carbon material and sodium metal, i.e., what is called a simple substance of sodium. Note that the meaning of the “simple substance” is as described above. The electrolyte salt in the electrolytic solution includes any one or more of sodium salts. Specific examples of the sodium salt include sodium salts corresponding to the above-described specific examples of the lithium salt.

In this case also, it is possible to easily and stably obtain a sufficient discharge capacity upon charging and discharging of the secondary battery. It is thus possible to achieve similar effects.

Regarding the positive electrode 100 described above, the example case has been described in which the sulfur-containing material includes the alkali metal polysulfide. However, the sulfur-containing material may include the alkaline earth metal polysulfide, more specifically, a magnesium polysulfide.

A secondary battery that includes the positive electrode 21 to which the positive electrode 100 is applied, and the negative electrode 22, and in which the battery capacity is obtained through insertion and extraction of magnesium is what is called a magnesium-sulfur secondary battery.

The magnesium-sulfur secondary battery has a configuration that is similar to the above-described configuration of the lithium-sulfur secondary battery except for the following points.

The negative electrode active material is not particularly limited in kind, and specific examples thereof include a magnesium-based material. The magnesium-based material is a material including magnesium as a constituent element, and may be a simple substance of magnesium, a magnesium alloy, a magnesium compound, a mixture of two or more thereof, or a material including two or more phases thereof. Note that the meaning of the “simple substance” is as described above. A metal element, other than magnesium, included as a constituent element in the magnesium alloy is not particularly limited in kind, and may be selected as desired. The magnesium compound includes any one or more of non-metallic elements including, without limitation, carbon, oxygen, sulfur, and a halogen as one or more constituent elements. Specific examples of the halogen include fluorine, chlorine, bromine, and iodine.

The electrolyte salt in the electrolytic solution includes any one or more of magnesium salts. The magnesium salt is not particularly limited in kind. When the electrolyte salt includes the magnesium salt, the solvent in the electrolytic solution preferably includes the ether (the straight-chain ether) represented by Formula (3). One reason for this is that this facilitates stable dissolution of the electrolyte salt in the solvent.

Specifically, the magnesium salt is a magnesium salt represented by Formula (4).

MgXₙ (4)
where:
X is a monovalent or divalent anion; and
n is 1 or 2.

When X in Formula (4) is a halogen ion, the magnesium salt is what is called a halogen metal salt. Specific examples of the halogen include F, Cl, Br, and I.

Needless to say, X may be an ion other than the halogen ion. Specific examples of the magnesium salt when X is an ion other than the halogen ion include magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg[B(C₆H₅)_{4]2}), magnesium hexafluorophosphate (Mg(PF₆)₂), magnesium hexafluoroarsenate (Mg(AsF₆)₂), a magnesium salt of perfluoroalkylsulfonate (Mg(RfSO₃)₂), a magnesium salt of perfluoroalkylsulfonylimide (Mg((Rf₂SO₂)₂N)₂), a magnesium salt of hexaalkyldisilazide (Mg[N(SiR₃)₂]), and Mg[B(OCH(CRff₃)₂)_{4]2}. Note that Rf represents a perfluoroalkyl group, and R represents an alkyl group. Each of 48 Rff's is any of H or F, and each of one or more of 48 Rff's are F.

In particular, the magnesium salt preferably includes a halogen-based magnesium salt, an imide-based magnesium salt, or both. One reason for this is that this further increases the energy density. In this case, the magnesium salt may simply include either the halogen-based magnesium salt or the imide-based magnesium salt, or may include both the halogen-based magnesium salt and the imide-based magnesium salt.

The halogen-based magnesium salt is the magnesium salt represented by Formula (4) where X is a halogen ion. Specific examples of the halogen-based magnesium salt include magnesium fluoride (MgF₂), magnesium chloride (MgCl₂), magnesium bromide (MgBr₂), and magnesium iodide (MgI₂). In particular, the halogen-based magnesium salt is preferably magnesium chloride. One reason for this is that this allows for a sufficiently high energy density.

The imide-based magnesium salt is a magnesium salt having an imide-type molecular structure, and is preferably a magnesium salt having a sulfonylimide-type molecular structure. One reason for this is that this allows for a higher energy density. In particular, combination use of the imide-based magnesium salt and the halogen-based magnesium salt allows for an even higher energy density.

Specific examples of the imide-based magnesium salt include the above-described magnesium salt of perfluoroalkylsulfonylimide. In particular, in the structural formula (Mg(Rf₂SO₂)₂N) of the magnesium salt of perfluoroalkylsulfonylimide, carbon number of the perfluoroalkyl group (Rf) may be within a range from 1 to 10 both inclusive, may be within a range from 1 to 8 both inclusive, may be within a range from 1 to 6 both inclusive, may be within a range from 1 to 4 both inclusive, may be within a range from 1 to 3 both inclusive, or may be 1 or 2. Specific examples of the magnesium salt of perfluoroalkylsulfonylimide include magnesium bis(trifluoromethanesulfonyl)imide (Mg(CF₃SO₂)₂N). In particular, combination use of magnesium bis(trifluoromethanesulfonyl)imide and magnesium chloride allows for an even higher energy density.

In this case also, it is possible to easily and stably obtain a sufficient discharge capacity upon charging and discharge of the secondary battery, and is thus possible to achieve similar effects.

In FIG. 5, the separator 23 that is the porous film is used. However, although not specifically illustrated here, a separator of a stacked type including a polymer compound layer may be used instead of the separator 23 that is the porous film.

Specifically, the separator of the stacked type includes a porous film having two opposed surfaces, and the polymer compound layer provided on one of or each of the two opposed surfaces of the porous film. This improves adherence of the separator to each of the positive electrode 21 and the negative electrode 22, and therefore suppresses misalignment of the battery device 20, that is, winding displacement of each of the positive electrode 21, the negative electrode 22, and the separator. This suppresses swelling of the secondary battery even if a decomposition reaction of the electrolytic solution occurs. The polymer compound layer includes a polymer compound such as polyvinylidene difluoride. One reason for this is that the polymer compound such as polyvinylidene difluoride is superior in physical strength and is electrochemically stable.

Note that the porous film, the polymer compound layer, or both may include multiple insulating particles. One reason for this is that the insulating particles dissipate heat upon heat generation by the secondary battery, thus improving safety or heat resistance of the secondary battery. The insulating particles include any one or more of insulating materials including, without limitation, inorganic particles and resin particles. Specific examples of the inorganic particles include particles of aluminum oxide, aluminum nitride, boehmite, silicon oxide, titanium oxide, magnesium oxide, and zirconium oxide. Specific examples of the resin particles include particles of acrylic resin and styrene resin.

When the separator of the stacked type is to be fabricated, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed by suppression of the misalignment of the battery device 20, as described above. Accordingly, it is possible to achieve higher effects.

In FIG. 5, the electrolytic solution, which is a liquid electrolyte, is used. However, although not specifically illustrated here, an electrolyte layer that is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this suppresses leakage of the electrolytic solution. The configuration of the electrolytic solution is as described above. The polymer compound includes, for example, polyvinylidene difluoride. When the electrolyte layer is to be formed, a precursor solution including, without limitation, the electrolytic solution, the polymer compound, and an organic solvent is prepared, following which the precursor solution is applied on one side or both sides of the positive electrode 21 and on one side or both sides of the negative electrode 22.

When the electrolyte layer is used also, lithium is movable in an ionic state between the positive electrode 21 and the negative electrode 22 via the electrolyte layer, and similar effects are therefore achievable. In this case, in particular, the leakage of the electrolytic solution is suppressed, as described above. Accordingly, it is possible to achieve higher effects.

Applications (application examples) of the secondary battery are not particularly limited. The secondary battery used as a power source may serve as a main power source or an auxiliary power source of, for example, electronic equipment and an electric vehicle. The main power source is preferentially used regardless of presence of any other power source. The auxiliary power source is used in place of the main power source, or is switched from the main power source.

Specific examples of the applications of the secondary battery include electronic equipment, apparatuses for data storage, electric power tools, battery packs, medical electronic equipment, electric vehicles, and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. The battery packs are each to be mounted on, for example, electronic equipment. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that operates or travels using the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

Needless to say, the secondary battery may have applications other than the series of applications described here as examples.

### EXAMPLES

A description is given of Examples of the present technology according to an embodiment.

### Examples 1 to 4 and Comparative Examples 1 to 3

Secondary batteries were fabricated, following which the secondary batteries were each evaluated for a battery characteristic, as described below.

### [Manufacturing of Secondary Battery]

The secondary battery was manufactured by the following procedure.

Here, a test secondary battery was fabricated to conduct a simple evaluation as the evaluation for the battery characteristic. FIG. 6 illustrates a sectional configuration of the test secondary battery, which is a lithium-sulfur secondary battery of a coin type.

As illustrated in FIG. 6, the secondary battery included a test electrode 61, a counter electrode 62, a separator 63, an outer package cup 64, an outer package can 65, a gasket 66, and an electrolytic solution (not illustrated). Here, the test electrode 61 served as a positive electrode, and the counter electrode 62 served as a negative electrode.

The test electrode 61 was placed in the outer package cup 64, and the counter electrode 62 was placed in the outer package can 65. The test electrode 61 and the counter electrode 62 were stacked on each other with the separator 63 interposed therebetween. The test electrode 61, the counter electrode 62, and the separator 63 were each impregnated with the electrolytic solution. The outer package cup 64 and the outer package can 65 were crimped to each other with the gasket 66 interposed therebetween. The test electrode 61, the counter electrode 62, and the separator 63 were each thus sealed in the outer package cup 64 and the outer package can 65.

### [Fabrication of Test Electrode]

When the test electrode 61 was to be fabricated, the firing method was used. Specifically, first, the holding particles 121, a positive electrode binder (polyethylene glycol), and an aqueous solvent (water) were mixed with each other to thereby obtain an aqueous paste. The holding particles 121 each included anatase-type titanium oxide (anatase-type TiO₂) or anatase-type titanium oxide (boron-doped anatase-type TiO₂) doped with a dopant (boron) at 4 mol % with respect to titanium. In this case, a mixture ratio (a weight ratio) between the holding particles 121 and the positive electrode binder was set to 90:10.

Thereafter, the aqueous paste was applied on one of the two opposed surfaces of the positive electrode current collector 110 (a titanium foil having a thickness of 20 μm) to thereby form a coating film. Thereafter, the coating film was pressure-bonded to the positive electrode current collector 110 by pressing the positive electrode current collector 110 with the coating film formed thereon by a roll pressing machine.

Lastly, the positive electrode current collector 110 with the coating film formed thereon was fired (at a firing temperature of 750° C. for a firing time of one hour) in the atmosphere. The positive electrode binder was thus degreased. Accordingly, the holding particles 121 were sintered with each other to form the porous structure 124.

Thereafter, the positive electrode current collector 110 with the porous structure 124 formed thereon was punched into a disk shape (having a diameter of 15 mm).

Thereafter, a sulfur-containing material (lithium sulfide (Li₂S₈) as a lithium polysulfide) was added to a solvent (1,2-dimethoxyethane), following which the solvent was stirred to thereby prepare a sulfur-containing solution. In this case, a concentration of the sulfur-containing solution was set to 200 mmol/l (=200 mmol/dm³).

Lastly, the positive electrode current collector 110 with the porous structure 124 formed thereon was immersed in the sulfur-containing solution (for an immersion time of one hour), following which the positive electrode current collector 110 with the porous structure 124 formed thereon was taken out of the sulfur-containing solution and dried. This allowed the positive electrode active material particles 122 (the sulfur-containing material) to be each held by any one of the holding particles 121. The test electrode 61 was thus fabricated.

A test electrode 61 for comparison was fabricated by a similar procedure except that rutile-type titanium oxide (rutile-type TiO₂) was used as the material to be included in the holding particles 121, instead of anatase-type titanium oxide.

Another test electrode 61 for comparison was fabricated by a similar procedure except that a carbon material (Ketjen black) was used as the material (the material) to be included in the holding particles 121, instead of the anatase-type titanium oxide. In this case, a coating method was used as the fabrication method of the test electrode 61. Specifically, the positive electrode active material (the carbon material), a positive electrode binder (a styrene-butadiene-based rubber), and a dispersant (carboxymethyl cellulose) were put into a solvent (a mixture of water as an aqueous solvent and ethanol as an organic solvent) to thereby prepare a mixture slurry in paste form. Thereafter, the mixture slurry was applied on one of the two opposed surfaces of the positive electrode current collector 110, and the applied mixture slurry was dried.

A “Porous structure” column in Table 1 indicates whether the porous structure 124 was formed. “Formed” indicates that the porous structure 124 was formed, as a result of formation of a sintered body of the holding particles 121. “Not formed” indicates that the porous structure 124 was not formed, as a result of non-formation of the sintered body of the holding particles 121.

### [Fabrication of Counter Electrode]

An alkali metal (a lithium metal plate) as the negative electrode active material was punched into a disk shape (having a diameter of 16 mm). The counter electrode 62 was thus obtained.

### [Preparation of Electrolytic Solution]

An electrolyte salt (lithium bis(trifluoromethanesulfonyl)imide (LiN(CF₃SO₂)₂) and lithium nitrate (LiNO₃)) was added to a solvent (1,2-dimethoxy ethane as an ether), following which the solvent was stirred. In this case, a content of the electrolyte salt (lithium bis(trifluoromethanesulfonyl)imide) was set to 1 mol/l (=1 mol/dm³) with respect to the solvent, and a content of the electrolyte salt (lithium nitrate) was set to 1 mol/l (=1 mol/dm³) with respect to the solvent. The electrolytic solution was thus prepared.

### [Assembly of Secondary Battery]

First, the test electrode 61 was placed in the outer package cup 64, and the counter electrode 62 was placed in the outer package can 65. Thereafter, the test electrode 61 placed in the outer package cup 64 and the counter electrode 62 placed in the outer package can 65 were stacked on each other with the separator 63 (a glass-fiber separator having a thickness of 200 μm), impregnated with the electrolytic solution, interposed therebetween. In this case, the test electrode 61 was so disposed that the positive electrode active material layer 120 was opposed to the counter electrode 62 with the separator 63 interposed therebetween. Lastly, the outer package cup 64 and the outer package can 65 were crimped to each other by the gasket 66 in a state where the test electrode 61 and the counter electrode 62 were stacked on each other with the separator 63 interposed therebetween. The test electrode 61 and the counter electrode 62 were thereby sealed in the outer package cup 64 and the outer package can 65. The secondary battery was thus completed.

After the completion of the secondary battery, the secondary battery was disassembled to thereby collect the test electrode 61. With use of the collected test electrode 61, the average particle size AS (nm) of the holding particles 121 was calculated by the above-described procedure. This revealed the calculation results of the average particle size AS presented in Table 1.

### [Evaluation of Battery Characteristic]

The secondary batteries were each evaluated for each of an initial charge and discharge characteristic and a battery capacity characteristic as the battery characteristic, which revealed the results presented in Table 1.

### [Initial Charge and Discharge Characteristic]

First, a charge capacity (mAh) and a discharge capacity (mAh) of the secondary battery were measured by cyclic voltammetry in an ambient temperature environment (at a temperature of 25° C.). In this case, a current (mA) was measured while a potential (V) was swept within a range from 1.9 V to 2.8 V both inclusive at a sweep rate of 0.01 mV/sec, to thereby obtain a correlation (cyclic voltammogram) between the potential and the current.

Thereafter, the cyclic voltammogram was divided into a discharge region, i.e., a region with a negative current, and a charge region, i.e., a region with a positive current. Thus, the discharge capacity was calculated by integrating the current in the discharge region, based on time, and the charge capacity was calculated by integrating the current in the charge region, based on time.

Lastly, initial efficiency serving as an index for evaluating the initial charge and discharge characteristic was calculated based on the following calculation expression: initial efficiency (%)=charge capacity (mAh)/discharge capacity (mAh).

### [Battery Capacity Characteristic]

After the measurement of the above-described discharge capacity (mAh), first, the secondary battery was disassembled to collect the test electrode 61, and the positive electrode current collector 110 was removed from the positive electrode active material layer 120. Thereafter, the positive electrode active material layer 120 was put into an organic solvent (1,2-dimethoxy ethane) and the organic solvent was stirred, following which the organic solvent was filtered. Because the positive electrode active material particles 122 were dissolved in the organic solvent, a residue as an undissolved component was collected. The residue included the porous structure 124 (the holding particles 121).

Thereafter, a surface area (m²) of the porous structure 124 was measured. In this case, a fully automated specific surface area measurement apparatus Macsorb (registered trademark) available from Mountech Co., Ltd. was used as a surface area measurement apparatus. Further, the porous structure 124 was subjected to degassing (at a heating temperature of 200° C. for a heating time of 30 minutes), following which the surface area was measured by a BET method (using a nitrogen gas).

Lastly, a basic capacity serving as an index for evaluating the battery capacity characteristic was calculated based on the following calculation expression: basic capacity (mAh/m²)=discharge capacity (mAh)/surface area (m²).

TABLE 1

| | | | | Positive | | |
|---|---|---|---|---|---|---|
| | | | | electrode | | |
| | | | | active material | | |
| | Holding particles | | | particles | | |
| | | Average | | Material | | |
| | | particle | | (Sulfur- | Initial | Basic |
| | | size | Porous | containing | efficiency | capacity |
| | Material | (nm) | structure | material) | (%) | (mAh/m²) |
| Example 1 | Anatase-type | 7 | Formed | Li₂S₈ | 96 | 14 |
| | TiO₂ | | | | | |
| Example 2 | Anatase-type | 30 | Formed | Li₂S₈ | 97 | 10 |
| | TiO₂ | | | | | |
| Example 3 | Anatase-type | 100 | Formed | Li₂S₈ | 93 | 8 |
| | TiO₂ | | | | | |
| Example 4 | Anatase-type | 30 | Formed | Li₂S₈ | 91 | 14 |
| | TiO₂ | | | | | |
| | (boron- | | | | | |
| | doped) | | | | | |
| Comparative | Anatase-type | 500 | Formed | Li₂S₈ | — | — |
| example 1 | TiO₂ | | | | | |
| Comparative | Rutile-type | 30 | Formed | Li₂S₈ | 13 | 2 |
| example 2 | TiO₂ | | | | | |
| Comparative | Ketjen black | 4 | Not | Li₂S₈ | 92 | 2 |
| example 3 | | | formed | | | |

As indicated in Table 1, the initial efficiency and the basic capacity each varied greatly depending on the configuration of the test electrode 61.

Specifically, when the material included in the holding particles 121 was the rutile-type titanium oxide and the porous structure 124 was formed (Comparative example 2), the initial efficiency markedly decreased and the basic capacity markedly decreased.

When the material included in the holding particles 121 was the carbon material (Ketjen black) and the porous structure 124 was not formed (Comparative example 3), the initial efficiency markedly increased but the basic capacity markedly decreased.

In contrast, when the material included in the holding particles 121 was the anatase-type titanium oxide and the porous structure 124 was formed (Examples 1 to 4 and Comparative example 1), the initial efficiency and the basic capacity each varied depending on the average particle size AS.

When the average particle size AS was greater than 100 nm (Comparative example 1), a charge and discharge reaction did not proceed, which made it impossible to perform the calculation of each of the initial efficiency and the basic capacity.

However, when the average particle size AS was 100 nm or less (Examples 1 to 3), the charge and discharge reaction proceeded, which allowed for the calculation of each of the initial efficiency and the basic capacity. In this case, the initial efficiency markedly increased and the basic capacity also markedly increased.

In particular, when the average particle size AS was 100 nm or less (Examples 1 to 3), if the average particle size AS was 30 nm or less, more specifically, within a range from 7 nm to 30 μm both inclusive, the initial efficiency further increased and the basic capacity also further increased.

When the boron-doped anatase-type titanium oxide was used as the material included in the holding particles 121 (Example 4), the initial efficiency was maintained at a markedly high rate and the basic capacity further increased, as compared with when the anatase-type titanium oxide not doped with boron was used (Example 2).

Based upon the results presented in Table 1, when: the positive electrode 100 included the positive electrode current collector 110 and the positive electrode active material layer 120; the positive electrode active material layer 120 included the holding particles 121 (the anatase-type titanium oxide) and the positive electrode active material particles 122 (the sulfur-containing material); the positive electrode active material layer 120 included the porous structure 124; the porous structure 124 included the holding particles 121 directly joined to each other and was directly coupled to the positive electrode current collector 110; the positive electrode active material particles 122 were each held by any one of the holding particles 121; and the average particle size AS of the holding particles 121 was 100 nm or less, high initial efficiency was obtained and a high basic capacity was also obtained. Both the initial charge and discharge characteristic and the battery capacity characteristic thus improved. Accordingly, it was possible to achieve a superior battery characteristic of the secondary battery.

Although the configuration of the secondary battery of the present technology has been described above with reference to some embodiments and Examples, the configuration of the secondary battery of the present technology is not limited to the configurations described with reference to the embodiments and Examples above, and is modifiable in a variety of ways.

Specifically, the description has been given of the case where the secondary battery has a battery structure of the laminated-film type or the coin type. However, the device structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, of a stacked type or a zigzag folded type. In the stacked type, the positive electrode and the negative electrode are stacked on each other. In the zigzag folded type, the positive electrode and the negative electrode are folded in a zigzag manner.

The effects described herein are mere examples, and effects of the present technology are therefore not limited to those described herein. Accordingly, the present technology may achieve any other effect.

Note that the present technology may have any of the following configurations according to an embodiment.

(1)

A secondary battery including:
a positive electrode;
a negative electrode; and
an electrolytic solution, in which
the positive electrode includes
   a positive electrode current collector, and
   a positive electrode active material layer supported by the positive electrode current collector,
the positive electrode active material layer includes
   multiple holding particles each including anatase-type titanium oxide, and
   multiple positive electrode active material particles each including a sulfur-containing material,
the holding particles form a porous structure by being directly joined to each other,
the porous structure is directly coupled to the positive electrode current collector,
the positive electrode active material particles are each held by any one of the holding particles, and
the holding particles have an average particle size of 100 nanometers or less.
   (2)

The secondary battery according to (1), in which the average particle size is 30 nanometers or less.

(3)

The secondary battery according to (1) or (2), in which the sulfur-containing material includes an alkali metal polysulfide.

(4)

The secondary battery according to (3), in which the alkali metal polysulfide includes a lithium polysulfide.

(5)

The secondary battery according to any one of (1) to (4), in which the secondary battery includes a lithium-sulfur secondary battery.

(6)

A positive electrode for a secondary battery, the positive electrode including:
a positive electrode current collector; and
a positive electrode active material layer supported by the positive electrode current collector, in which
the positive electrode active material layer includes
   multiple holding particles each including anatase-type titanium oxide, and
   multiple positive electrode active material particles each including a sulfur-containing material,
the holding particles form a porous structure by being directly joined to each other,
the porous structure is directly coupled to the positive electrode current collector,
the positive electrode active material particles are each held by any one of the holding particles, and
the holding particles have an average particle size of 100 nanometers or less.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the positive electrode includes
a positive electrode current collector, and
a positive electrode active material layer supported by the positive electrode current collector,
the positive electrode active material layer includes
multiple holding particles each including anatase-type titanium oxide, and
multiple positive electrode active material particles each including a sulfur-containing material,
the holding particles form a porous structure by being directly joined to each other,
the porous structure is directly coupled to the positive electrode current collector,
the positive electrode active material particles are each held by any one of the holding particles, and
the holding particles have an average particle size of 100 nanometers or less.

2. The secondary battery according to claim 1, wherein the average particle size is 30 nanometers or less.

3. The secondary battery according to claim 1, wherein the sulfur-containing material includes an alkali metal polysulfide.

4. The secondary battery according to claim 3, wherein the alkali metal polysulfide includes a lithium polysulfide.

5. The secondary battery according to claim 1, wherein the secondary battery comprises a lithium-sulfur secondary battery.

6. A positive electrode for a secondary battery, the positive electrode comprising:
a positive electrode current collector; and
a positive electrode active material layer supported by the positive electrode current collector, wherein
the positive electrode active material layer includes
multiple holding particles each including anatase-type titanium oxide, and
multiple positive electrode active material particles each including a sulfur-containing material,
the holding particles form a porous structure by being directly joined to each other,
the porous structure is directly coupled to the positive electrode current collector,
the positive electrode active material particles are each held by any one of the holding particles, and
the holding particles have an average particle size of 100 nanometers or less.
